(19) United States
(12) Patent Application Publication
(10) Pub. No.: US 2016/0224464 A1
(43) Pub. Date: Aug. 4, 2016

(54) Valid Data Compression On SSD

(71) Applicant: BiTMICRO Networks, Inc., Fremont, CA (US)

(72) Inventors: Marvin Dela Cruz Fenol, Bacood Santa Mesa (PH); Jik-Jik Oyong Abed, Pasay City (PH); Precious Nezaiah Umali Pestano, Quezon City (PH); Benedict Centeno Bantigue, Dagupan City (PH); Joevannl Baliton Parairo, san Rafael (PH)

(21) Appl. No.: 15/002,329

(22) Filed: Jan. 20, 2016

Related U.S. Application Data
(63) Continuation-in-part of application No. 14/690,370, filed on Apr. 17, 2015.
(60) Provisional application No. 61/980,594, filed on Apr. 17, 2014.

(51) Int. Cl. G06F 12/02; G06F 12/06; G06F 3/06

(52) U.S. Cl. CPC G06F 12/0246; G06F 3/0605; G06F 3/0608; G06F 3/064; G06F 3/0647; G06F 3/0652; G06F 3/0679; G06F 12/0253; G06F 12/0646; G06F 2212/1044; G06F 2212/214; G06F 2212/7202; G06F 2212/7205; G06F 2212/7206

(57) ABSTRACT

In an embodiment of the invention, a method comprises: obtaining a first data block with a lowest number of valid data from a block record; moving a first valid data in a first memory data area of the first data block to a first pre-erased memory data area in a second data block; and moving a second valid data in a second memory data area in the first data block to a second pre-erased memory data area in the second data block. In another embodiment of the invention, an article of manufacture comprises: a non-transient computer-readable medium having stored thereon instructions that are configured to: obtain a first data block with a lowest number of valid data from a block record; move a first valid data in a first memory data area of the first data block to a first pre-erased memory data area in a second data block; and move a second valid data in a second memory data area in the first data block to a second pre-erased memory data area in the second data block. In yet another embodiment of the invention, an apparatus comprises: a data storage system configured to: obtain a first data block with a lowest number of valid data from a block record; move a first valid data in a first memory data area of the first data block to a first pre-erased memory data area in a second data block; and move a second valid data in a second memory data area in the first data block to a second pre-erased memory data area in the second data block.

### CROSS-REFERENCE(S) TO RELATED APPLICATIONS

This application is a continuation-in-part of U.S. application Ser. No. 14/690,370 which claims the benefit of and priority to U.S. Provisional Application 61/980,594. The U.S. Application Nos. 61/980,594 and Ser. No. 14/690,370 are hereby fully incorporated herein by reference.

### FIELD

Embodiments of the invention relate generally to data storage systems. Embodiments of the invention also relate generally to valid data compression on solid state drives.

### DESCRIPTION OF RELATED ART

The background description provided herein is for the purpose of generally presenting the context of the disclosure of the invention. Work of the presently named inventors, to the extent the work is described in this background section, as well as aspects of the description that may not otherwise qualify as prior art at the time of filing, are neither expressly nor impliedly admitted as prior art against this present disclosure of the invention.

Compacting, generally known as garbage collection in solid state device (SSD) jargon, is the process of making a flash block free of valid data written on the flash block at a particular instance. The need for compacting arises from the intertwined hardware limitations, firmware data access, and non-sequential access of the host which results in data being distributed unevenly throughout the physical memory. This is an essential process in a pre-erased data management algorithm to replenish flash blocks ready for erasure and eventually for writing.

Most common flash devices are capable of erase only on the block level while writes can be done on page level. Firmware data access further decreases the logical granularity of memory into sections that increases the chance of data being physically scattered. In addition to hardware and firmware considerations, random host accesses of small chunks of data hasten the dilemma of data scattering.

One conventional approach involves adding a marker and a counter of valid data within the certain block and looking for a block that has less valid data and then transferring that valid data to a new block, and then subsequently looking again for another block with less valid data. However, this type of data being collected is limited to the same type of data. Therefore, there is a continuing need to overcome the constraints or disadvantages of conventional approaches.

### SUMMARY

A problem in conventional approaches is that some blocks hold less valid data, and the valid data are spread to other blocks. An advantage provided by an embodiment of the invention include, by way of example and not by way of limitation, is the capability to collect all valid data in blocks that carry less valid data and to then transfer these collected valid data to a new block. By transferring the collected valid data of blocks that carry less valid data from one block to another, a system (or apparatus) and/or method according to an embodiment of the invention can produce free blocks.

In an embodiment of the invention, a method comprises: obtaining a first data block with a lowest number of valid data from a block record; moving a first valid data in a first memory data area of the first data block to a first pre-erased memory data area in a second data block; and moving a second valid data in a second memory data area in the first data block to a second pre-erased memory data area in the second data block.

In another embodiment of the invention, an article of manufacture comprises: a non-transient computer-readable medium having stored thereon instructions that are configured to: obtain a first data block with a lowest number of valid data from a block record; move a first valid data in a first memory data area of the first data block to a first pre-erased memory data area in a second data block; and move a second valid data in a second memory data area in the first data block to a second pre-erased memory data area in the second data block.

In yet another embodiment of the invention, an apparatus comprises: a data storage system configured to: obtain a first data block with a lowest number of valid data from a block record; move a first valid data in a first memory data area of the first data block to a first pre-erased memory data area in a second data block; and move a second valid data in a second memory data area in the first data block to a second pre-erased memory data area in the second data block.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF DRAWINGS

Non-limiting and non-exhaustive embodiments of the present invention are described with reference to the following figures, wherein like reference numerals refer to like parts throughout the various views unless otherwise specified.

It is to be noted, however, that the appended drawings illustrate only typical embodiments of this invention and are therefore not to be considered limiting of its scope, for the present invention may admit to other equally effective embodiments.

FIG. 1 is a block diagram of a system that can permit valid data compression or compacting process, in accordance with an embodiment of the invention.

FIG. 2 is a block diagram that illustrates a compacting process in accordance with an embodiment of the invention.

FIG. 3 is a flow diagram of a method for data compacting such as, for example, control data compacting, in accordance with an embodiment of the invention.

### DETAILED DESCRIPTION

In the following detailed description, for purposes of explanation, numerous specific details are set forth to provide a thorough understanding of the various embodiments of the present invention. Those of ordinary skill in the art will realize that these various embodiments of the present invention are illustrative only and are not intended to be limiting in any way. Other embodiments of the present invention will readily suggest themselves to such skilled persons having the benefit of this disclosure.

In addition, for clarity purposes, not all of the routine features of the embodiments described herein are shown or described. One of ordinary skill in the art would readily appreciate that in the development of any such actual implementation, numerous implementation-specific decisions may be required to achieve specific design objectives. These design objectives will vary from one implementation to another and from one developer to another. Moreover, it will be appreciated that such a development effort might be complex and time-consuming, but would nevertheless be a routine engineering undertaking for those of ordinary skill in the art having the benefit of this disclosure. The various embodiments disclosed herein are not intended to limit the scope and spirit of the herein disclosure.

Exemplary embodiments for carrying out the principles of the present invention are described herein with reference to the drawings. However, the present invention is not limited to the specifically described and illustrated embodiments. A person skilled in the art will appreciate that many other embodiments are possible without deviating from the basic concept of the invention. Therefore, the principles of the present invention extend to any work that falls within the scope of the appended claims.

As used herein, the terms “a” and “an” herein do not denote a limitation of quantity, but rather denote the presence of at least one of the referenced items.

As used herein, the terms “a” and “an” herein do not denote a limitation of quantity, but rather denote the presence of at least one of the referenced items.

In the following description and in the claims, the terms “include” and “comprise” are used in an open-ended fashion, and thus should be interpreted to mean “include, but not limited to . . . ”. Also, the term “couple” (or “coupled”) is intended to mean either an indirect or direct electrical connection (or an indirect or direct optical connection). Accordingly, if one device is coupled to another device, then that connection may be through a direct electrical (or optical) connection, or through an indirect electrical (or optical) connection via other devices and/or other connections.

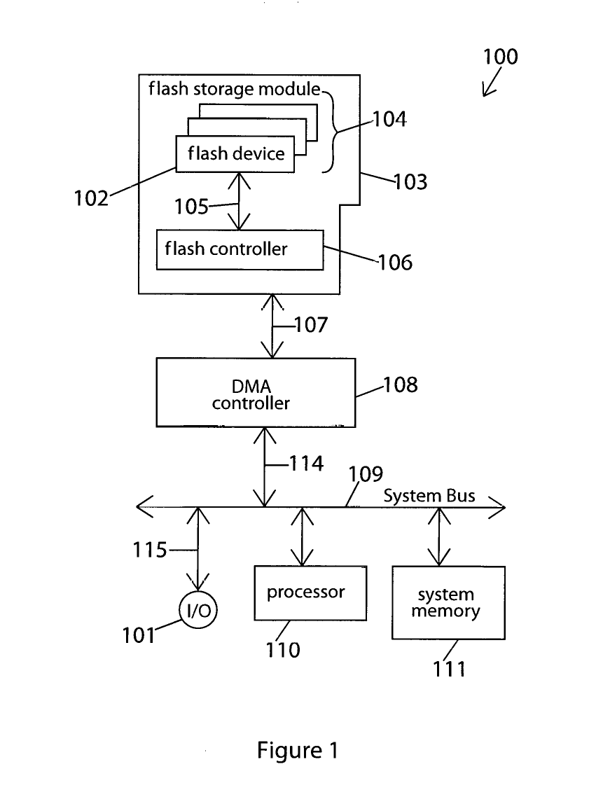

FIG. 1 is a block diagram of an example data storage system 100 (or data storage apparatus 100) that can include an embodiment of the invention. Those skilled in the art with the benefit of this disclosure will realize that an embodiment of the invention can be included in other suitable types of computing systems or data storage systems.

When the system 100 has initialized and is under normal operation, a software/program 101 (run by the processor requests for the SSD access), for example, will do a read transaction to read data from one or more non-volatile memory devices 102 in the flash storage module 103 or do a write transaction to write data to one or more non-volatile memory devices 102 in the flash storage module 103. Typically, the one or more memory devices 102 form a memory device array 104 in the flash module 103. The memory device array 104 is coupled via a flash interface 105 to a flash memory controller 106.

The flash storage module 103 is coupled via a flash bus 107 (or memory bus 107) to a Direct Memory Access (DMA) controller 108. The DMA controller 108 is coupled via a DMA bus interface 114 to a system bus 109.

A processor 110, system memory 111, and a software/program 101 (run by processor) are all coupled to the system bus 109. The system 100 can include more than one software/program 101, more than one processor 110, and/or more than one system memory 111. Additionally or alternatively, the system 100 can include more than one DMA controller 108 and more than one flash storage module 103. In an embodiment of the invention that includes a plurality of flash storage modules 103 and a plurality of DMA controllers 108, wherein each flash storage module 103 is coupled via a respective flash bus 107 to a respective DMA controller 108, the plurality of flash storage modules 103 will form an array (not shown) of flash storage modules 103.

System bus 109 is a conduit or data path for transferring data between DMA controller 108, processor 110, system memory 111, and software/program 101. Processor 110, DMA controller 108, and software/program 101 may access system memory 111 via system bus 109 as needed. System memory 111 may be implemented using any form of memory, such as, for example, various types of DRAM (dynamic random access memory), non-volatile memory, or other types of memory devices.

A request 115 for a memory transaction (e.g., read or write transaction) from software/program 101, typically in the form of an input-output descriptor command, is destined for the processor 110. Descriptor commands are detailed instructions to be executed by an engine or a module. The processor 110 interprets that the input-output descriptor command intends to read from memory devices 102 in the flash storage module 103 or intends to write to memory devices 102 in the flash storage module 103. The processor 110 is in-charge of issuing all the needed descriptors to one or more Direct Memory Access (DMA) controllers 108 to execute a read memory transaction or write memory transaction in response to the request 115. Therefore, the DMA controller 108, flash memory controller 106, and processor 110 allow at least one device, such as a software/program 101, to communicate with memory devices 102 within the data storage apparatus 100. Operating under a program control (such as a control by software or firmware), the processor 110 analyzes and responds to a memory transaction request 115 by generating DMA instructions that will cause the DMA controller 108 to read data from or write data to the flash devices 102 in a flash storage module 103 through the flash memory controller 106. If this data is available, the flash memory controller 106 retrieves this data, which is transferred to system memory 111 by the DMA controller 108. Data obtained during this memory read transaction request is hereinafter named “read data”. Similarly, write data provided by software/program 101 will cause the DMA controller 108 to write data to the flash devices 102 through the flash memory controller 106.

A non-volatile memory device 102 in the flash storage module 103 may be, for example, a flash device. This flash device may be implemented by using a flash memory device that complies with the Open NAND Flash Interface Specification, commonly referred to as ONFI Specification. The term “ONFI Specification” is a known device interface standard created by a consortium of technology companies known as the “ONFI Workgroup”. The ONFI Workgroup develops open standards for NAND Flash memory devices and for devices that communicate with these NAND flash memory devices. The ONFI Workgroup is headquartered in Hillsboro, Oregon. Using a flash device that complies with the ONFI Specification is not intended to limit the embodiment(s) disclosed herein. One of ordinary skill in the art having the benefit of this disclosure would readily recognize that other types of flash devices employing different device interface protocols may be used, such as protocols that are compatible with the standards created through the Non-Volatile Memory Host Controller Interface (NVMHCI) working group. Members of the NVMHCI working group include Intel Corporation of Santa Clara, Calif., Dell Inc. of Round Rock, Texas, and Microsoft Corporation of Redmond, Wash.

Those skilled in the art with the benefit of this disclosure will realize that there can be multiple components in the system 100 such as, for example, multiple processors, multiple memory arrays, multiple DMA controllers, and/or multiple flash controllers.

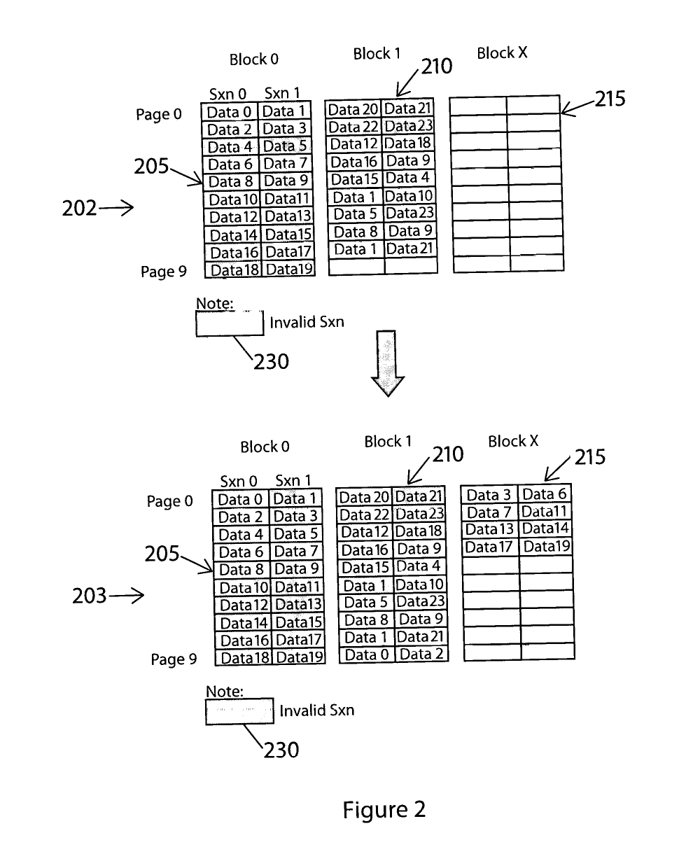

FIG. 2 is a block diagram that shows data blocks and their data before and after a compacting process in the system 100 (FIG. 1), in accordance with an embodiment of the invention. The compacting process can be performed by, for example, a DMA controller (e.g., DMA controller 108) or a processor (e.g., processor 110) executing a program/software or firmware.

Data Block (0) 205 shows that valid data and invalid data can be found in a data block when sections are updated. Data Block (0) 205 and Data Block (1) 210 initially show that valid data and invalid data can be found in a data block when sections (Sxn 0 and Sxn 1) are updated.

During step (202), in Block (0), data 0 (at page 0, sxn 0 of the block), data 2 (page 1, sxn 0), data 6 (page 4, sxn 0), and data 14 (page 8, sxn 0), data 3 (page 2, sxn 1), data 7 (page 4, sxn 1), data 11 (page 6, sxn 1), data 13 (page 7, sxn 1), data 14 (page 7, sxn 0), data 17 (page 8, sxn 1), and data 19 (page 9, sxn 1) are data (i.e., a plurality of valid data) in valid data sections when data sections are updated. Data 1 (page 0, sxn 1), Data 4 (page 2, sxn 0), data 5 (page 2, sxn 1), data 8 (page 4, sxn 0), data 9 (page 4, sxn 1), data 10 (page 5, sxn 0), data 12 (page 6, sxn 0), data 15 (page 7, sxn 1), data 16 (page 8, sxn 0), and data 18 (page 9, sxn 0) are data in invalid data sections when data sections are updated. In this example, block 205 has the lowest number of valid data from the Block Record (Block List) in system 100. For example, block 205 has a lower number of valid data than the valid data in block 210.

In step (203), the data in the valid sections from block (0) 205 are relocated to block (1) 210 and block (X) 215. Hence data appears to be compacted on block (1) and block (X) and block (0) is now fully invalid as shown by shaded symbol 230. When a block becomes fully invalid, the fully invalid block (block 205 in step 203) becomes a candidate for erasure and can be used again for writes. In step (203), data 0 (page 0, sxn 0, in block (0) 205) is moved to valid section at page 9, sxn 0, in block 210; data 2 (page 1, sxn 0 in block 205) is moved to valid section at page 9, sxn 1, in block 210. The remaining data in valid sections of block 205 (e.g., data 3, data 6, data 7, data 11, data 13, data 14, data 17, and data 19) are moved to valid sections in block (X) 215. Therefore, block 215 now has data 3 (page 0, sxn 0 in block (X) 215), data 7 (page 1, sxn 0 in block (X) 215), data 13 (page 2, sxn 0 in block (X) 215) and data 17 (page 3, sxn 0 in block (X) 215) in pages 0 through 3, section 0 of block 215, respectively. Block 215 now also has data 6 (page 0, sxn 1 in block (X) 215), data 11 (page 1, sxn 1 in block (X) 215), data 14 (page 2, sxn 1 in block (X) 215) and data 19 (page 3, sxn 1 in block (X) 215) in pages 0 through 3, section 1 of block 215, respectively. Block (0) 205 is now fully invalid, as shown by the shaded symbol 230 in each data sections 0 and 1 and is a candidate for erasure, after step (203) is completed.

In block 210, the memory data area at page 9 and section 0 is in a pre-erased state before data 0 is moved to this memory data area (page 9, sxn 0) in block 210 from the memory data area at (page 0, sxn 0) in block 205. In block 210, the memory data area at page 9 and section 1 is in a pre-erased state before data 2 is moved to this memory data area (page 9, sxn 1) in block 210 from the memory data area at (page 0, sxn 0) in block 205.

Similarly, the memory data areas at (page 0, sxn 0; page 1, sxn 0; page 2, sxn 0; page 3, sxn 0; page 0, sxn 1; page 1, sxn 1; page 2, sxn 1, and page 3, sxn 1) in block 215 are each in a pre-erased state before data (data 3, data 7, data 13, data 17, data 6, data 11, data 14, and data 19) are moved to these memory data areas at (page 0, sxn 0; page 1, sxn 0; page 2, sxn 0; page 3, sxn 0; page 0, sxn 1; page 1, sxn 1; page 2, sxn 1, and page 3, sxn 1) in block 215 from the memory data areas (page 1, sxn 1; page 3, sxn 1; page 6, sxn 1; page 8, sxn 1; page 3, sxn 0; page 5, sxn 1; page 7, sxn 0; page 9, sxn 1) at block 205, respectively.

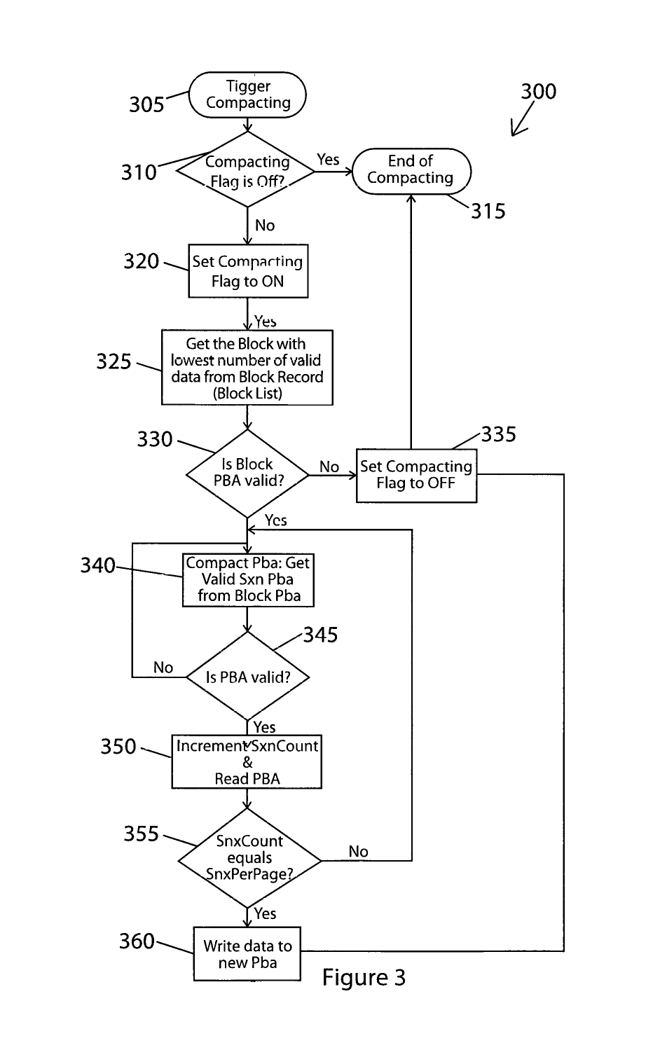

FIG. 3 is a flow diagram of a method 300 for data compacting such as, for example, control data compacting, in accordance with an embodiment of the invention. As noted above, a DMA controller (e.g., DMA controller 108) or a processor (e.g., processor 110) executes a program/software or firmware to permit the performance of the method 300 for data compacting.

As an example, the DMA controller 108 in the system 100 performs the following method 300 for data compacting. As noted above, the processor 110 in the system 100 can also perform this process 300. At 305, the DMA controller 108 triggers the compacting process of method 300.

At 310, the DMA controller 108 checks if a compacting flag is set to OFF (i.e., the DMA controller 108 checks if the compacting flag is unset). If the compacting flag is set to OFF, then the method 300 proceeds to 315. At 315, the DMA controller 108 ends the compacting process of method 300. If the compacting flag is not set to OFF, then the method 300 proceeds to 320. At 320, the DMA controller 108 sets the compacting flag to ON and starts the compacting process of 300.

At 325, the DMA controller 108 gets (obtains) a data block with the lowest number of valid data from a Block Record (Block List) of the system 100 (i.e., the DMA controller 108 gets a data block with the lowest number of valid data sections from a block record of the system 100). In the example shown in FIG. 2, the block (0) 205 has the lowest number of valid data from a block record of the system 100. For example, the block (0) 205 has a lower number of valid data that the number of valid data of block (1) 210 in system 100. A block record is a list that contains a specific number of valid sections per block.

At 330, the DMA controller 108 checks the validity of the block PBA (physical block address of the data block). If the block PBA is not valid, then the method 300 proceeds to 335. At 335, the DMA controller 108 sets the compacting flag to OFF (i.e., if the Block PBA is not valid, the compacting flag will be unset) and the DMA controller 108 will end the compacting process of method 300 at 315.

At 330, if the Block PBA is valid, then the method 300 proceeds to 340. At 340, the DMA controller 108 gets (obtains) a valid section (sxn) PBA from the block PBA.

At 345, the DMA controller 108 checks the validity of the section PBA. If the section PBA is not valid, then the method 300 proceeds to 340 wherein the DMA controller 108 gets another valid section PBA from the block PBA and then checks the validity of that other section PBA at 345.

At 345, if the section PBA is valid, then the method 300 proceeds to 350. A section PBA is valid if the section PBA has valid data. At 350, since the section PBA is valid, the DMA controller 108 increments a section count (SxnCount) value and reads the section PBA.

At 355, the DMA controller 108 checks if the section count value is equal to the sections per page (SxnPerPage) value. If the section count value is not equal to the sections per page value, then the method 300 proceeds to 340. At 340, the DMA controller 108 gets another valid section to be compacted from the data block.

At 355, if the section count value is equal to the sections per page value, then the method 300 proceeds to 360 and then proceeds to 355 and 315 since all section PBAs in the block PBA have been checked by the DMA controller 108. At 360, the DMA controller 108 writes the data in the valid section PBA (i.e., DMA controller 108 writes data in all valid section PBAs) to new section PBAs which are in a pre-erased state. At 335, the DMA controller 108 unsets the compacting flag. At 315, the DMA controller 108 ends the compacting process of method 300.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless.

It is also within the scope of the present invention to implement a program or code that can be stored in a non-transient machine-readable (or non-transient computer-readable medium) having stored thereon instructions that permit a method (or that permit a computer) to perform any of the inventive techniques described above, or a program or code that can be stored in an article of manufacture that includes a non-transient computer readable medium on which computer-readable instructions for carrying out embodiments of the inventive techniques are stored. Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
obtaining a first data block with a lowest number of valid data from a block record;
moving a first valid data in a first memory data area of the first data block to a first pre-erased memory data area in a second data block; and
moving a second valid data in a second memory data area in the first data block to a second pre-erased memory data area in the second data block.

2. The method of claim 1, wherein the first data block becomes a candidate for erasure after all memory data areas in the first data block become invalid.

3. The method of claim 1, further comprising:
erasing the first data block after all memory data areas in the first data block become invalid.

4. The method of claim 1, further comprising:
moving a third valid data in the first data block to a third pre-erased memory data area in a third data block.

5. The method of claim 1, further comprising:
moving each valid data in the first data block to a given pre-erased memory data area in either the second data block or third data block.

6. The method of claim 1, wherein the first valid data is in a first section of a first page of the first data block and wherein the second valid data is in a section of a page that does not contain the first valid data; and
wherein the first pre-erased memory data area is a given section of a given page in the second data block.

7. The method of claim 1, further comprising:
changing a compacting flag to end a compacting process on the first data block.

8. An article of manufacture, comprising:
a non-transient computer-readable medium having stored thereon instructions that are configured to:
obtain a first data block with a lowest number of valid data from a block record;
move a first valid data in a first memory data area of the first data block to a first pre-erased memory data area in a second data block; and
move a second valid data in a second memory data area in the first data block to a second pre-erased memory data area in the second data block.

9. The article of manufacture of claim 8, wherein the first data block becomes a candidate for erasure after all memory data areas in the first data block become invalid.

10. The article of manufacture of claim 8, wherein the instructions are further configured to:
erase the first data block after all memory data areas in the first data block become invalid.

11. The article of manufacture of claim 8, wherein the instructions are further configured to:
move a third valid data in the first data block to a third pre-erased memory data area in a third data block.

12. The article of manufacture of claim 8, wherein the first valid data is in a first section of a first page of the first data block and wherein the second valid data is in a section of a page that does not contain the first valid data; and
wherein the first pre-erased memory data area is a given section of a given page in the second data block.

13. The article of manufacture of claim 8, wherein the instructions are further configured to:
move each valid data in the first data block to a given pre-erased memory data area in either the second data block or third data block.

14. An apparatus, comprising:
a data storage system configured to:
obtain a first data block with a lowest number of valid data from a block record;
move a first valid data in a first memory data area of the first data block to a first pre-erased memory data area in a second data block; and
move a second valid data in a second memory data area in the first data block to a second pre-erased memory data area in the second data block.

15. The apparatus of claim 14, wherein the first data block becomes a candidate for erasure after all memory data areas in the first data block become invalid.

16. The apparatus of claim 14, wherein the data storage system is further configured to:
erase the first data block after all memory data areas in the first data block become invalid.

17. The apparatus of claim 14, wherein the data storage system is further configured to:
move a third valid data in the first data block to a third pre-erased memory data area in a third data block.

18. The apparatus of claim 14, wherein the data storage system is further configured to:
move each valid data in the first data block to a given pre-erased memory data area in either the second data block or third data block.

19. The apparatus of claim 14, wherein the first valid data is in a first section of a first page of the first data block and wherein the second valid data is in a section of a page that does not contain the first valid data; and
wherein the first pre-erased memory data area is a given section of a given page in the second data block.

20. The apparatus of claim 14, wherein the data storage system is further configured to:
change a compacting flag to end a compacting process on the first data block.
